(19) United States
(12) Patent Application Publication
(10) Pub. No.: US 2026/0178466 A1
(43) Pub. Date: Jun. 25, 2026

(54) CONTEXT-AWARE STATIC CODE ANALYSIS

(71) Applicant: MICROSOFT TECHNOLOGY LICENSING, LLC, Redmond, WA (US)

(72) Inventors: Vishal GOYAL, Delhi (IN); Siddharth G R, Bangalore (IN); Arulanandan PONNIVALAVAN, Bengaluru (IN); Nivedita RAJANI, Bengaluru (IN)

(21) Appl. No.: 18/991,303

(22) Filed: Dec. 20, 2024

(51) Int. Cl. G06F 11/3604

(52) U.S. Cl. CPC G06F 11/3608

(57) ABSTRACT

Disclosed are techniques for identifying software defects in source code. Initially, a defect detection engine analyzes the source code to identify a list of defects. In some configurations, multiple defect detection engines are applied, such as a source code linter or a machine learning-based tool, and the results are merged into a single list. Then, each defect is re-evaluated based on calling contexts. Specifically, code that calls the defective code is identified and analyzed to determine if the calling code mitigates the defect. For example, client code that calls a database stored procedure may be analyzed to determine if constraints applied by the client code mitigate a defect found in the stored procedure.

### BACKGROUND

Software defects, such as security vulnerabilities, crashes, and inefficient algorithms, are technically challenging to identify programmatically. For example, defects can be subtle, and as such require a sophisticated understanding of software code and runtime environments to identify programmatically. This difficulty is exacerbated in applications created with multiple programming languages. Different programming languages typically have incompatible type systems, error handling techniques, and memory models. Defect detection engines often fail at the boundary between two languages due to these differences. For example, many traditional defect detection techniques rely on the type system of a programming language to guarantee program correctness. However, when code transitions to a different language having a different type system, these guarantees can no longer be maintained.

It is with respect to these and other considerations that the disclosure made herein is presented.

### SUMMARY

Disclosed are techniques for identifying software defects in source code. Initially, a defect detection engine analyzes the source code to identify a list of defects. In some configurations, multiple defect detection engines are applied, such as a source code linter or a machine learning-based tool, and the results are merged into a single list. Then, each defect is re-evaluated based on calling contexts. Specifically, code that calls the defective code is identified and analyzed to determine if the calling code mitigates the defect. For example, client code that calls a database stored procedure may be analyzed to determine if constraints applied by the client code mitigate a defect found in the stored procedure.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIGS. 1A-1B illustrate generating a list of defects.

FIGS. 2A-2C illustrate mitigating a defect based on a context-aware defect analysis.

FIG. 3 is a flow diagram of an example method for performing context-aware static code analysis.

FIG. 4 is a computer architecture diagram illustrating an illustrative computer hardware and software architecture for a computing system capable of implementing aspects of the techniques and technologies presented herein.

### DETAILED DESCRIPTION

Static source code analysis is performed by analyzing source code used to create a software application. This contrasts with a runtime analysis, which analyzes logs or error reports generated as a software application executes. Static source code analysis may be performed for several reasons—to validate program correctness, identify performance problems, identify security vulnerabilities, etc. Some static source code analysis engines output a list of defects, including where the defect was found in the source code, the type of defect, the severity of the defect, etc.

Analyzing source code has many advantages and some disadvantages compared to other analysis techniques. For example, static source code analysis may be integrated into a development workflow, such as by checking for defects as changes are made to the source code. This enables defects to be identified before the application is subject to internal testing or before it is deployed to an end-user's machine. Static source code analysis may also be integrated into a software development environment, enabling developers to identify defects as the application is being developed.

Some of the techniques described herein may optionally be enhanced by or implemented in part using machine learning. Machine learning (ML) is a branch of artificial intelligence (AI) that develops systems capable of learning and improving from experience without explicit programming. It encompasses a broad spectrum of technologies, ranging from foundational algorithms to advanced architectures like large language models (LLMs) and transformers.

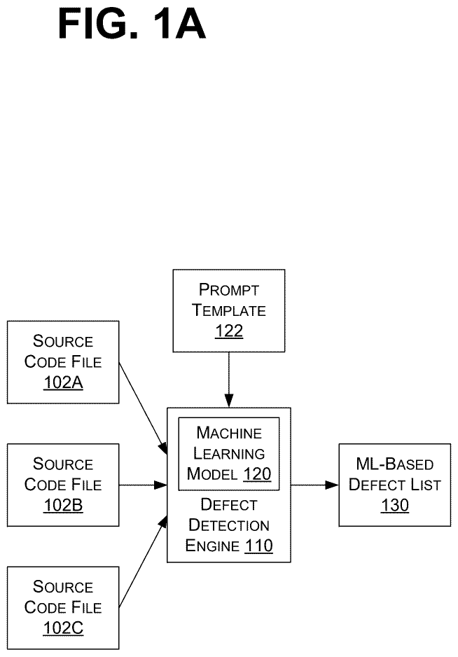

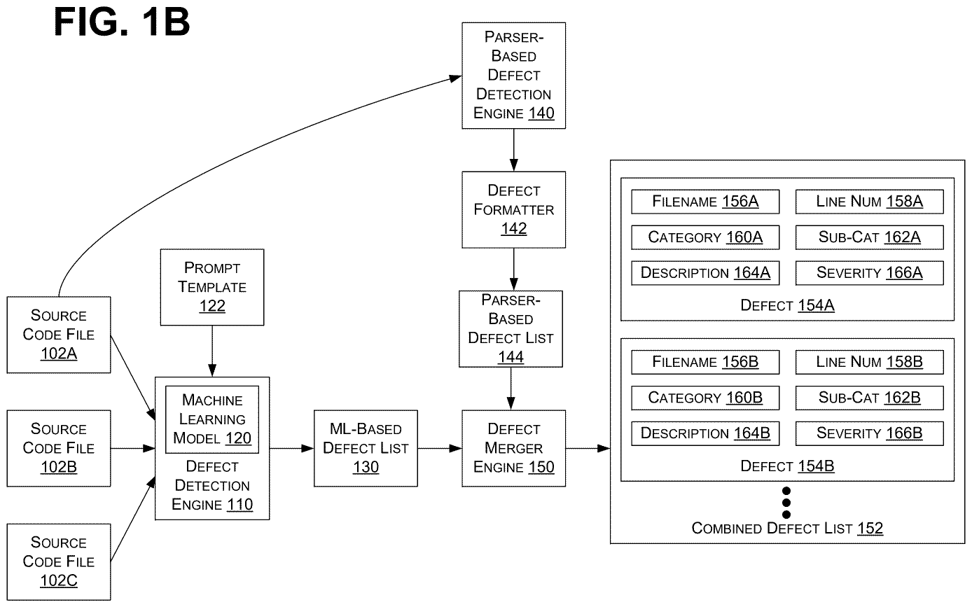

FIG. 1A illustrates generating an initial list of defects. Source code files 102 are provided to defect detection engine 110 for analysis. Source code files 102 may be provided automatically to defect detection engine 110 as part of a code check-in or continuous integration process. In other configurations, one or more of source code files 102 may be selected by a user for analysis. Additionally, or alternatively, a portion of source code file 102 may be selected for analysis.

Defect detection engine 110 utilizes machine learning model 120 to analyze one or more source code files 102. In some configurations, prompt template 122 describes a task for machine learning model 120 to perform, such as:

What are the possible vulnerabilities in this code? Categorize in terms of “Security”, “Code quality”, “Memory leaks”, “Performance”, “Others”. Return the data in a tabular format with these headings: Category, Sub-category, Starting Line number, Short Description, Severity. Output should only contain categories for which issues are found. Output each line separately:

Source code extracted from source code files 102 may be appended to prompt template 122 before being provided to machine learning model 120. While this example prompt includes five categories, this is just one illustrative embodiment. Any number of categories is similarly contemplated. Furthermore, the categories listed—“security”, “code quality”, “memory leaks”, “performance”, and “others” are examples—other categories, such as style violation, are similarly contemplated. Similarly, the headings of “Category”, “Sub-category”, “Starting Line number”, “Short Description”, and “Severity” are illustrative examples, but other headings such as a DREAD (Damage, Reproducibility, Exploitability, Affected users, Discoverability) score are similarly contemplated.

In some configurations, prompt template 122 may override a default value that would otherwise have been generated by machine learning model 120. For example, prompt template 122 may indicate that “Category: Security and Sub-category: SQL Injection should have a Severity: Critical”, strongly suggesting that machine learning model 120 should indicate as much.

In some configurations, machine learning model 120 analyzes each source code file 102 separately. In other configurations, defect detection engine 110 may pre-process one or more of source code files 102 before providing them to machine learning model 120 for analysis. For example, defect detection engine 110 may split one of source code files 102 into smaller portions to accommodate an input token limit of machine learning model 120. The results of analyzing each portion of one of source code files 102 are then aggregated into a single list. Defect detection engine 110 may optionally combine or otherwise synthesize two or more of source code files 102 before processing the combination.

In some configurations, source code files 102 have the same file type, or are otherwise known to include source code written in the same or similar programming language. For example, source code files 102 could have “.cpp” or “.h” extension, and contain c++ code. Additionally, or alternatively, source code files 102 could include source code written in different programming languages. For example, source code file 102A may be written in a procedural programming language such as C#, while source code file 102B may be written in a relational programming language such as T-SQL.

Defect detection engine 110 outputs defects identified at least in part by machine learning model 120 as machine learning-based defect list 130. Machine learning-based defect list 130 may include defects found in some or all of source code files 102, or defect detection engine 110 may generate one machine learning-based defect list 130 for each source code file.

Continuing the example prompt 122 reproduced above, after analyzing a T-SQL stored procedure of source code file 102B, ML-based defect list 130 may include a defect with the category of “Security”, a sub-category of “SQL Injection”, a starting line number of “6”, a short description of “Parameters are directly used in the query, making it vulnerable to SQL injection”, and a severity of “high.” Similarly, after an analysis of C #code, ML-based defect list 130 may include an entry with the category of “Security”, a sub-category of “SQL Injection”, a starting line number of “23”, a short description of “Parameters are added without specifying the parameter name, making it vulnerable to SQL injection”, and a severity of “High”.

FIG. 1B illustrates applying a parser-based defect detection engine to generate another defect list. Parser-based defect detection engine 140 receives one or more of source code files 102. Parser-based defect detection engine 140 may be a linter—code that analyzes source code to identify defects. In some configurations, parser-based defect detection engine 140 may utilize regular expressions, parser generators, recursive descent parsers, compiler front-ends, and other tools that analyze source code. In this context, parser-based refers to procedural code, in contrast with machine learning-based parsers.

Parser-based defect detection engine 140 may identify the same defect as defect detection engine 110. In some configurations, in order to avoid this duplication, a machine learning model may be prompted to confirm whether a defect identified by defect detection engine 110 is the same defect identified by parser-based defect detection engine. For example, a large language model may be provided with a prompt such as “Do these two code vulnerabilities mean the same thing if in the context of the same line in the code?”, followed by the descriptions of each vulnerability provided by the different defect detection engines. If the answer is yes, only one of the defects is allowed to remain, typically the defect identified by machine learning model 120 of defect detection engine 110. If the defects are determined to be different, defect formatter 142 converts the output of parser-based defect detection engine 140 to have a format generated by defect detection engine 110. The results are stored in parser-based defect list 144. Defect formatter 142 may use a machine learning model to conform the output of parser-based defect detection engine 140 to a format that would be generated by defect detection engine 110.

Defects identified by defect detection engine 110 and parser-based defect detection engine 140 may be merged into combined defect list 152 by defect merger engine 150. Combined defect list 152 includes example categories of information, such as filename 156, line number 158, category 160, sub-category 162, description 164, and severity 166. These categories are selected for illustrative purposes only, and other types of information usable to describe a defect are similarly contemplated, such as a detailed description, an error code, etc.

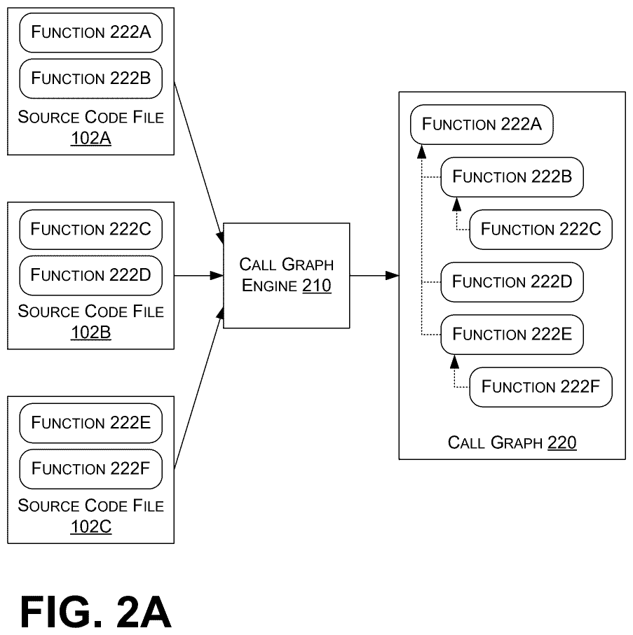

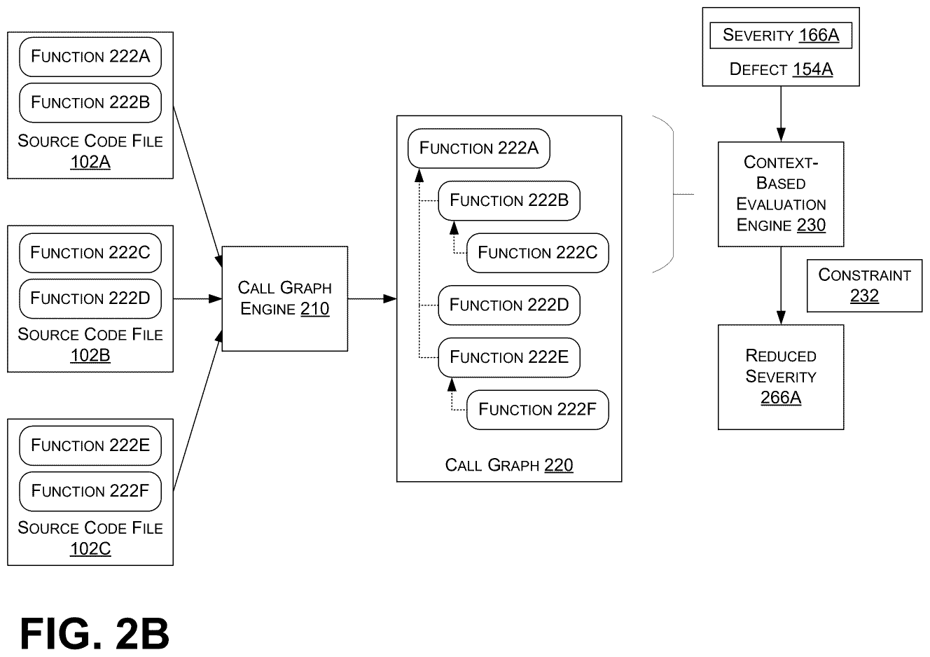

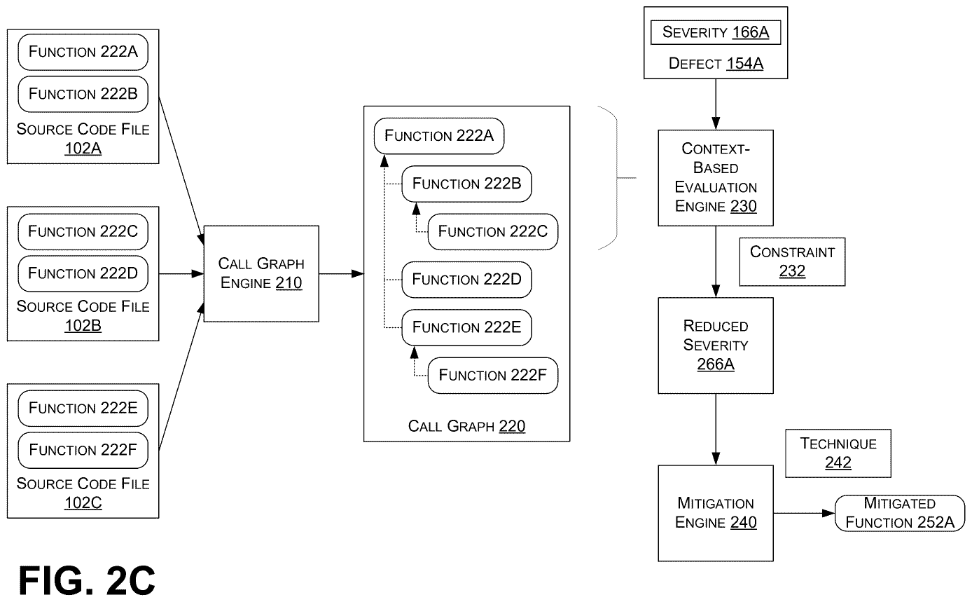

FIGS. 2A-2C illustrate mitigating a defect based on a context-aware defect analysis. FIG. 2A illustrates identifying a call graph from source code files 102. Source code is often grouped into functions, classes, code blocks, and other collections of source code statements. Functions—also referred to as methods, may be invoked by calling code. After the function completes the program resumes executing at the next statement of the calling code. Functions are often passed parameters or access global state, and so the context in which a function is invoked may affect the outcome of the function.

FIG. 2A illustrates functions 222, where function 222C and function 222B are found in source code file 102A, functions 222A and 222D are found in source code file 102B, and functions 222E and 222F are found in source code file 102C. Call graph engine 210 analyzes the functions 222 of source code files 102 to identify when one function calls another. These relationships may be identified by parsing source code files 102 and/or performing string searches. For example, function 222A may be identified within source code file 102B using a parser that tokenizes source code 102B and constructs a parse tree. The parse tree may then be traversed to identify the names of functions such as function 222A.

With the name of function 222A, callers of function 222A may be found throughout the rest of source code file 102B and the rest of source code files 102. Callers may be found by traversing the parse tree of source code file 102B or the parse tress of other source code files. Additionally, or alternatively, callers may be found by performing a string search, e.g., using regular expressions, on source code files 102.

The search for calling functions may be recursive, resulting in multiple layers of functions being identified. For example, as illustrated, function 222F calls function 222E, which in turn calls function 222A. These relationships may be recorded in call graph 220.

FIG. 2B illustrates performing a context-based evaluation using a hierarchy of function calls. The hierarchy of functions calls, as represented by call graph 220, may be analyzed to determine if the code that calls a function constrains the callee in a way the mitigates a defect. For example, if function 222A is a stored procedure running on a database, and function 222B is C# code that calls the stored procedure, context-based evaluation engine 230 may identify constraint 232—limits on parameters passed to function 222A or global variables accessed by function 222A. For example, function 222B may sanitize parameters passed to function 222A, reducing the chance that function 222A will result in a defect.

In some configurations, context-based evaluation engine 230 leverages a machine learning model to determine whether one or more callers constrain function 222A enough to diminish or otherwise mitigate a defect. For example, context-based evaluation engine 230 may provide a prompt to a machine learning model followed by a copy of source code, such as “The previous analysis for function 222A had a Category of security, a Sub-category of SQL injection, and a severity of high. The code that follows is the only caller of function 222A. What is the new severity?”, followed by source code of function 222B.

This process may be repeated for all of the callers of function 222A. If all of these analyses return a severity that is less than the original severity, then the defect may be updated to reflect the reduced severity 266A.

In some configurations, multiple layers of callers may be recursively analyzed to determine if a constraint exists on input parameters of function 222A. A third layer of callers, such as functions 222C and 222F, may be analyzed to identify constraints on a second layer of callers, such as functions 222B, 222D, and 222E. Constraints on the second layer of callers may be used to determine whether the second layer of callers impose additional constraints on function 222A.

FIG. 2C illustrates mitigating a defect. Mitigation engine 240 manually or automatically applies a fix to defect 154A. In some configurations, mitigation engine 240 leverages a machine learning model to obtain a fix to defect 154A. For example, mitigation engine 240 may obtain technique 242 that, when applied to defect 154A, generates mitigated function 252A. Mitigated function 252A fixes, mitigates, or otherwise reduces the risk posed by defect 154A. Additionally, or alternatively, mitigation engine 240 may mitigate the defect by modifying callers of function 222A. For example, mitigation engine 240 may modify function 222B to add an additional constraint on the invocation of function 222A, or mitigation engine 240 may optimize away or otherwise omit the call to function 222A.

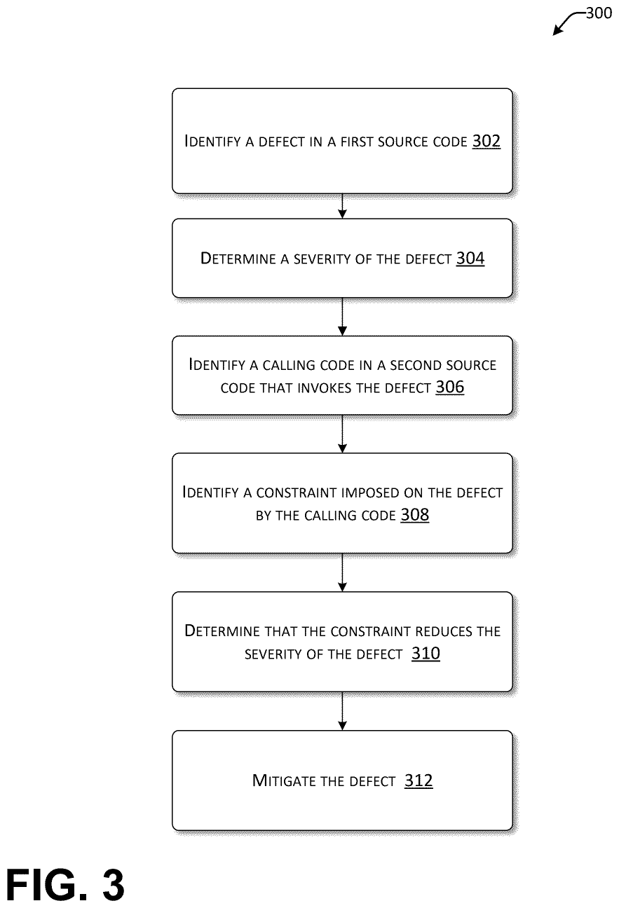

FIG. 3 is a flow diagram of an example method for context-aware static code analysis. Routine 300 begins at operation 302, where defect 154 is identified. Defect 154A may be identified by defect detection engine 110 which utilizes machine learning model 120. Machine learning model 120 may be a large language model, but convolutional neural networks, recurrent neural networks, or any other type of machine learning model is similarly contemplated. Defect 154A may be identified within a first source code file 102A.

Next at operation 304, a severity 166 of defect 154A is determined. Severity 166 may be determined by machine learning model 120. Additionally, or alternatively, a severity generated by machine learning model 120 may be selectively refined. For example, prompt template 122 may indicate that certain defects are to always have a particular severity.

Next at operation 306, a calling code such as function 222B is identified in a second source code file 102B as invoking defect 154A. In some configurations, a string comparison is performed across one or more of source code files 102 to identify invocations of function 222A.

Next at operation 308, constraint 232 imposed on defect 154A is identified within the calling code. As discussed above, constraint 232 may limit the values of parameters of function 222A, thereby limiting the values of variables used by defect 154A.

Next at operation 310, context-based evaluation engine 230 determines that constraint 323 reduces the severity of defect 154A, possibly eliminating it entirely. For example, function 222B may sanitize one or more of the parameters of a SQL stored procedure 222A.

Next at operation 312, mitigation engine 240 applies a mitigation technique 242 that is applied to source code file 102A to mitigate the effect of defect 154A. Mitigation technique 242 is tailored to mitigate defect 154A based on reduced severity 266A. In some configurations, mitigation technique 242 applies additional protections to the code that is associated with defect 154A. Additionally, or alternatively, calling code such as function 222B may be altered to further protect vulnerable function 222A.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 300 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 300 may be also implemented in many other ways. For example, the routine 300 may be implemented, at least in part, by a processor of another remote computer or a local circuit. In addition, one or more of the operations of the routine 300 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

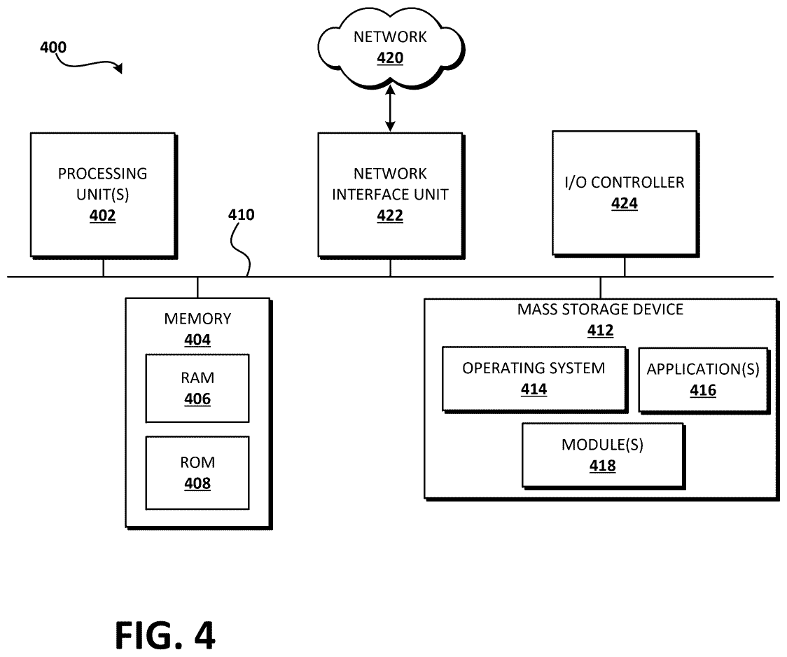

FIG. 4 shows additional details of an example computer architecture 400 for a device, such as a computer or a server configured as part of the systems described herein, capable of executing computer instructions (e.g., a module or a program component described herein). The computer architecture 400 illustrated in FIG. 4 includes processing unit(s) 402, a system memory 404, including a random-access memory 406 (“RAM”) and a read-only memory (“ROM”) 408, and a system bus 410 that couples the memory 404 to the processing unit(s) 402.

Processing unit(s), such as processing unit(s) 402, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 400, such as during startup, is stored in the ROM 408. The computer architecture 400 further includes a mass storage device 412 for storing an operating system 414, application(s) 416, modules 418, and other data described herein.

The mass storage device 412 is connected to processing unit(s) 402 through a mass storage controller connected to the bus 410. The mass storage device 412 and its associated computer-readable media provide non-volatile storage for the computer architecture 400. Although the description of computer-readable media contained herein refers to a mass storage device, it should be appreciated by those skilled in the art that computer-readable media can be any available computer-readable storage media or communication media that can be accessed by the computer architecture 400.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 400 may operate in a networked environment using logical connections to remote computers through the network 420. The computer architecture 400 may connect to the network 420 through a network interface unit 422 connected to the bus 410. The computer architecture 400 also may include an input/output controller 424 for receiving and processing input from a number of other devices, including a keyboard, mouse, touch, or electronic stylus or pen. Similarly, the input/output controller 424 may provide output to a display screen, a printer, or other type of output device.

It should be appreciated that the software components described herein may, when loaded into the processing unit(s) 402 and executed, transform the processing unit(s) 402 and the overall computer architecture 400 from a general-purpose computing system into a special-purpose computing system customized to facilitate the functionality presented herein. The processing unit(s) 402 may be constructed from any number of transistors or other discrete circuit elements, which may individually or collectively assume any number of states. More specifically, the processing unit(s) 402 may operate as a finite-state machine, in response to executable instructions contained within the software modules disclosed herein. These computer-executable instructions may transform the processing unit(s) 402 by specifying how the processing unit(s) 402 transition between states, thereby transforming the transistors or other discrete hardware elements constituting the processing unit(s) 402.

The present disclosure is supplemented by the following example clauses:
Example 1: A method comprising: identifying a defect in a first source code; determining a severity of the defect; identifying a calling code in a second source code that invokes the defect; identifying a constraint imposed on the defect by the calling code; determining that the constraint reduces the severity of the defect to a reduced severity; and mitigating the defect with a technique calibrated to the reduced severity.

Example 2: The method of Example 1, wherein the first source code is written in a different programming language than the second source code.

Example 3: The method of Example 1, wherein the reduced severity comprises a first reduced severity, the constraint comprises a first constraint, and the calling code comprises a first calling code, the method further comprising: determining a second reduced severity caused by a second constraint being imposed on the defect by the second calling code; and determining a least reduced severity between the first reduced severity and the second reduced severity, wherein the defect is mitigated with a technique calibrated to the least reduced severity.

Example 4: The method of Example 3, wherein the defect is identified using a machine learning-based defect detection engine.

Example 5: The method of Example 3, wherein the first defect is identified using a machine learning-based defect detection engine and wherein the second defect is identified using a parser-based defect detection engine.

Example 6: The method of Example 5, wherein a first machine learning model adapts an output of the parser-based defect detection engine to a format associated with the machine learning-based defect detection engine, and wherein a second machine learning model identifies defects identified by the machine learning-based defect engine and the parser-based defect engine.

Example 7: The method of Example 6, further comprising: displaying a listing that includes the first defect, the first reduced severity, the second defect, and the second reduced severity.

Example 8: A non-transitory computer-readable storage medium having computer-executable instructions stored thereupon that, when executed by a processor, cause the processor to: identify a defect in a first source code using a machine learning-based defect detection engine; determine a severity of the defect; identify a calling code in a second source code that invokes the defect; identify a constraint imposed on the defect by the calling code; determine that the constraint reduces the severity of the defect to a reduced severity; and mitigate the defect with a technique calibrated to the reduced severity.

Example 9: The non-transitory computer-readable storage medium of Example 8, wherein the defect comprises a security vulnerability, a logic error, an invalid memory access, or a performance issue.

Example 10: The non-transitory computer-readable storage medium of Example 8, wherein the defect is located within a function inside the first source code, and wherein the calling code invokes the function.

Example 11: The non-transitory computer-readable storage medium of Example 8, wherein the machine learning-based defect detection engine identifies the defect in the first source code in response to a prompt comprising at least a portion of the first source code, a request to identify defects and their severities, and format in which to describe defects.

Example 12: The non-transitory computer-readable storage medium of Example 8, wherein the calling code is identified using a call graph of an application compiled in part from the first source code.

Example 13: The non-transitory computer-readable storage medium of Example 8, wherein the defect is located in a function within the first source code, and wherein the calling code is identified by searching the second source code for an invocation of the function.

Example 14: The non-transitory computer-readable storage medium of Example 8, wherein the defect is located in a function within the first source code, and wherein the constraint limits a number of iterations of a loop of the function.

Example 15: A computing device comprising: a processor; and a non-transitory computer-readable storage medium storing computer-readable instructions that, when executed by the processor, cause the computing device to: identify a security vulnerability in a first source code; determine a severity of the security vulnerability; identify a calling code in a second source code that invokes the security vulnerability; identify a constraint imposed on the security vulnerability by the calling code; determine that the constraint reduces the severity of the security vulnerability to a reduced severity; and mitigate the security vulnerability with a technique calibrated to the reduced severity.

Example 16: The computing device of Example 15, wherein the security vulnerability is located in a function within the first source code, and wherein the constraint limits a value of a parameter of the function to a range of allowable values.

Example 17: The computing device of Example 15, wherein the security vulnerability is located in a function within the first source code, and wherein the constraint limits a value of a parameter of the function to an allowable data type.

Example 18: The computing device of Example 15, wherein mitigating the security vulnerability replaces at least a portion of the first source code with a corrected portion.

Example 19: The computing device of Example 15, wherein mitigating the security vulnerability modifies the second source code to include an additional constraint on the security vulnerability.

Example 20: The computing device of Example 15, wherein the calling code comprises a first calling code, wherein the constraint comprises a first constraint, wherein the reduced severity comprises a first reduced severity, and wherein the instructions further cause the computing device to: identify a second calling code in a third source code that invokes the first calling code; identify a second constraint imposed on the first calling code by the second calling code; and determine that the second constraint reduces the severity of the security vulnerability to a second reduced severity, wherein the security vulnerability is mitigated with a technique calibrated to the second reduced severity.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
identifying a defect in a first source code;
determining a severity of the defect;
identifying a calling code in a second source code that invokes the defect;
identifying a constraint imposed on the defect by the calling code;
determining that the constraint reduces the severity of the defect to a reduced severity; and
mitigating the defect with a technique calibrated to the reduced severity.

2. The method of claim 1, wherein the first source code is written in a different programming language than the second source code.

3. The method of claim 1, wherein the reduced severity comprises a first reduced severity, the constraint comprises a first constraint, and the calling code comprises a first calling code, the method further comprising:
determining a second reduced severity caused by a second constraint being imposed on the defect by the second calling code; and
determining a least reduced severity between the first reduced severity and the second reduced severity, wherein the defect is mitigated with a technique calibrated to the least reduced severity.

4. The method of claim 3, wherein the defect is identified using a machine learning-based defect detection engine.

5. The method of claim 3, wherein the first defect is identified using a machine learning-based defect detection engine and wherein the second defect is identified using a parser-based defect detection engine.

6. The method of claim 5, wherein a first machine learning model adapts an output of the parser-based defect detection engine to a format associated with the machine learning-based defect detection engine, and wherein a second machine learning model identifies defects identified by the machine learning-based defect engine and the parser-based defect engine.

7. The method of claim 6, further comprising:
displaying a listing that includes the first defect, the first reduced severity, the second defect, and the second reduced severity.

8. A non-transitory computer-readable storage medium having computer-executable instructions stored thereupon that, when executed by a processor, cause the processor to:
identify a defect in a first source code using a machine learning-based defect detection engine;
determine a severity of the defect;
identify a calling code in a second source code that invokes the defect;
identify a constraint imposed on the defect by the calling code;
determine that the constraint reduces the severity of the defect to a reduced severity; and
mitigate the defect with a technique calibrated to the reduced severity.

9. The non-transitory computer-readable storage medium of claim 8, wherein the defect comprises a security vulnerability, a logic error, an invalid memory access, or a performance issue.

10. The non-transitory computer-readable storage medium of claim 8, wherein the defect is located within a function inside the first source code, and wherein the calling code invokes the function.

11. The non-transitory computer-readable storage medium of claim 8, wherein the machine learning-based defect detection engine identifies the defect in the first source code in response to a prompt comprising at least a portion of the first source code, a request to identify defects and their severities, and format in which to describe defects.

12. The non-transitory computer-readable storage medium of claim 8, wherein the calling code is identified using a call graph of an application compiled in part from the first source code.

13. The non-transitory computer-readable storage medium of claim 8, wherein the defect is located in a function within the first source code, and wherein the calling code is identified by searching the second source code for an invocation of the function.

14. The non-transitory computer-readable storage medium of claim 8, wherein the defect is located in a function within the first source code, and wherein the constraint limits a number of iterations of a loop of the function.

15. A computing device comprising:
a processor; and
a non-transitory computer-readable storage medium storing computer-readable instructions that, when executed by the processor, cause the computing device to:
identify a security vulnerability in a first source code;
determine a severity of the security vulnerability;
identify a calling code in a second source code that invokes the security vulnerability;
identify a constraint imposed on the security vulnerability by the calling code;
determine that the constraint reduces the severity of the security vulnerability to a reduced severity; and
mitigate the security vulnerability with a technique calibrated to the reduced severity.

16. The computing device of claim 15, wherein the security vulnerability is located in a function within the first source code, and wherein the constraint limits a value of a parameter of the function to a range of allowable values.

17. The computing device of claim 15, wherein the security vulnerability is located in a function within the first source code, and wherein the constraint limits a value of a parameter of the function to an allowable data type.

18. The computing device of claim 15, wherein mitigating the security vulnerability replaces at least a portion of the first source code with a corrected portion.

19. The computing device of claim 15, wherein mitigating the security vulnerability modifies the second source code to include an additional constraint on the security vulnerability.

20. The computing device of claim 15, wherein the calling code comprises a first calling code, wherein the constraint comprises a first constraint, wherein the reduced severity comprises a first reduced severity, and wherein the instructions further cause the computing device to:
identify a second calling code in a third source code that invokes the first calling code;
identify a second constraint imposed on the first calling code by the second calling code; and
determine that the second constraint reduces the severity of the security vulnerability to a second reduced severity, wherein the security vulnerability is mitigated with a technique calibrated to the second reduced severity.
